(19) United States
(12) Patent Application Publication
(10) Pub. No.: US 2004/0215563 A1
(43) Pub. Date: Oct. 28, 2004

(54) System and method for collocating materials

(76) Inventors: Sheng Chi Luo, Tu-Chen (TW); Fucheng Wang, Shenzhen (CN); ZhiGang He, Shenzhen (CN); Andong Lee, Shenzhen (CN); Hua Xu, Shen zhen (CN); Jinli Ji, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/832,646

(22) Filed: Apr. 26, 2004

(30) Foreign Application Priority Data
Apr. 25, 2003 (TW) 92109681

(51) Int. Cl. G06F 17/60; H04K 1/00

(52) U.S. Cl. 705/40

(57) ABSTRACT

A system for collocating materials includes an application server (115), and a database server (117) connected with the server via a network (107). The application server manages shipment procedures, and includes: a bill generating module (307) for generating a shipment bill in accordance with a requirement of a client; a material collocating module (303) for collocating materials in accordance with the shipment bill; and a processing module (308) for management different shipment. The database server stores basic data related to collocating materials of the application server. A related method includes the steps of: (a) generating a shipment bill; (b) reading a client code from the shipment bill; (c) reading a material code and a quantity from the shipment bill; (d) selecting a supplier in accordance with the client code and the material code; (e) assigning one or more area codes and unit codes to the material; and (f) managing shipment procedure.

### BACKGROUND OF THE INVENTION

1. Field of the Invention

The present invention relates to a computer data process system in a management information system, and especially to a system and method for collocating materials via computers.

2. Background of the Invention

Globalized economic development has brought tremendous business opportunities to numerous enterprises, and has also brought more pressure to bear on manufacturing enterprises. For example, more and more customized products are being ordered by a wider range of customers, and customers are requiring more rigorous quality standards and more demanding delivery deadlines. Further, an enterprise's manufacturing may be conducted in a number of different countries around the world, making management of the enterprise a challenging task. A competitive enterprise needs to adopt new technologies, design new products, reduce manufacturing cycles of products, enhance productivity, and reduce costs. Such enterprise should also strengthen manufacturing management, such as supply of materials, product manufacturing, and merchandise distribution. The enterprise should further cooperate with suppliers, dealers, and customers to make the best of their shared and respective resources. By such means, the enterprise can achieve high customer satisfaction, and maintain keen competitiveness.

For a manufacturing enterprise, storage costs has always been a significant part of overall operating costs. Strengthening inventory management to reduce storage costs is an important way to reduce operating costs and increase profits. Computer systems help to enhance efficiency in the procedures of stocking and shipment in an inventory system. For example, P. R. China patent application No. 01120143.6 entitled “Automatic Management System And Method For Logistics” discloses a system for managing stock and shipment. The system uses a stock processing module, a collecting module, and a shipment processing module to automatically manage the procedures of stocking and shipment. The system can enhance efficiency in the procedures of stocking and shipment for a single client.

However, the system does not address the procedure of collocating materials before shipment, and does not address shipment in circumstances involving multiple suppliers, clients and materials.

### SUMMARY OF THE INVENTION

Accordingly, an objective of the present invention is to provide a system and method for shipment in circumstances involving multiple suppliers, clients and materials.

Another objective of the present invention is to provide a system and method for collocating materials before shipment.

In order to achieve the above-mentioned objectives, a system for collocating materials in accordance with the present invention comprises an application server, and a database server connected with the application server via a network. The application server manages shipment procedures, and comprises: a bill generating module for generating a shipment bill in accordance with a requirement of a client; a material collocating module for collocating materials in accordance with the shipment bill; and a processing module for managing shipment procedures in different shipment modes. The database server stores basic data related to collocating materials of the application server.

In order to achieve the above-mentioned objectives, a method for collocating materials in accordance with the present invention comprises the steps of: (a) generating a shipment bill; (b) reading a client code from the shipment bill; (c) reading a material code and a quantity from the shipment bill; (d) selecting a supplier in accordance with the client code and the material code; (e) assigning one or more area codes and unit codes to the material; and (f) managing a shipment procedure.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a system for collocating materials in accordance with a preferred embodiment of the present invention, the system comprising a plurality of client computers, an application server, a databases, and a plurality of workstations;

FIG. 2 is a block diagram of an organizational layout of a warehouse in which materials are stored;

FIG. 3 is a block diagram of function modules of the application server of FIG. 1;

FIG. 4 is a flow chart of shipment materials in accordance with the present invention; and

FIG. 5 is a flow chart of details of one step of FIG. 4, namely collocating materials.

### DETAILED DESCRIPTION OF PREFERRED EMBODIMENTS OF THE INVENTION

Reference will now be made to the drawings to describe the present invention in detail.

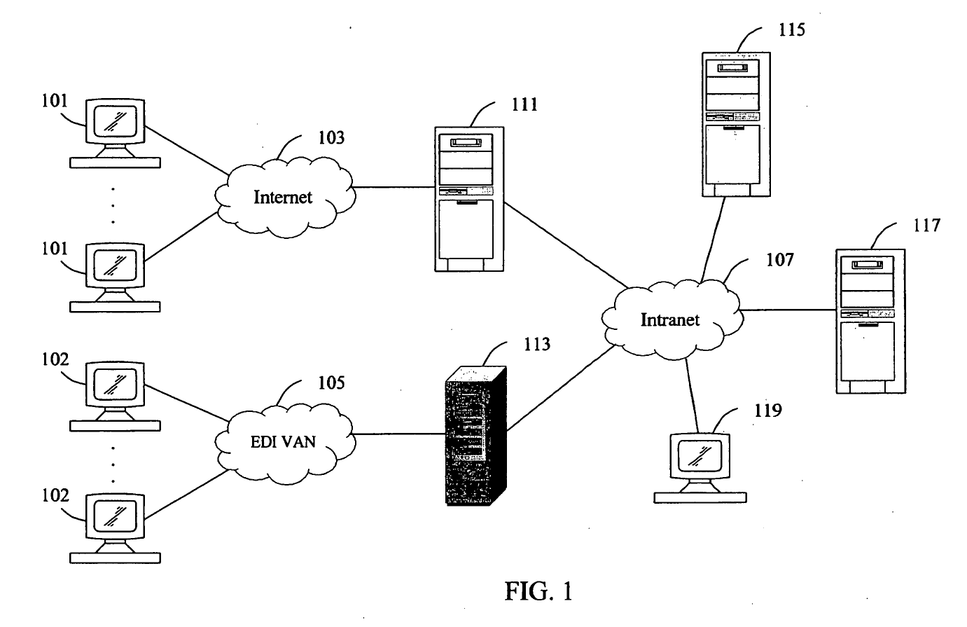

FIG. 1 is a schematic diagram of hardware configuration of a system for collocating materials in accordance with the preferred embodiment of the present invention. The system for collocating materials comprises a three-layer information system. The three-layer information system comprises a data access layer, a business logic layer, and a presentation layer. The data access layer comprises a database server 117. The business logic layer comprises an application server 115. The presentation layer comprises a plurality of workstations 119. For the purposes of conveniently illustrating the preferred embodiment of the present invention, only one workstation 119 is described hereinafter. An intranet 107 interconnects the business logic layer and the data access layer. The intranet 107 can also connect with an MRPII (Manufacture Resource Planning) system, an ERP (Enterprise Resource Planning) system, or another kind of information system.

The database server 117 has a database located therein, which stores all structured data (such as products, clients, and financing) of an enterprise that employs the system for collocating materials. The database server 117 is used for managing processing of the stored data. Such processing includes reading, writing, deleting, modifying, and backup. The application server 115 comprises core and mutable enterprise logic (such as rules, execution, and management) of the system for collocating materials. The application server 115 comprises a plurality of software modules (described in detail below in relation to FIG. 3), and provides functions for collocating materials. The workstation 119 is located in a respective one of warehouses, each warehouse having a respective workstation 119. Via the workstation 119, a user can access the application server 115 and manage collocating materials.

The intranet 107 is also interconnected with a web server 111 and an EDI (Electronic Data Interchange) server 113. The web server 111 connects with a plurality of client computers 101 via the internet 103. The EDI server 113 interchanges EDI data with a plurality of EDI terminals 102 via an EDI VAN (Value Added Network) 105. The EDI data comprise inventory information, shipment information, invoices and so on.

The client computers 101 and the EDI terminals 102 can also connect with an information system. The information system may connect with an MRPII (Manufacture Resource Planning) system, an ERP (Enterprise Resource Planning) system, or another kind of information system. The client computers 101 access the web server 111 via the internet 103 by using a browser such as Internet Explorer by Microsoft, or Navigator by Netscape. The web server 111 sends query requests from the client computers 102 to the application server 115, processes query results, and returns the query results to the client computers 102.

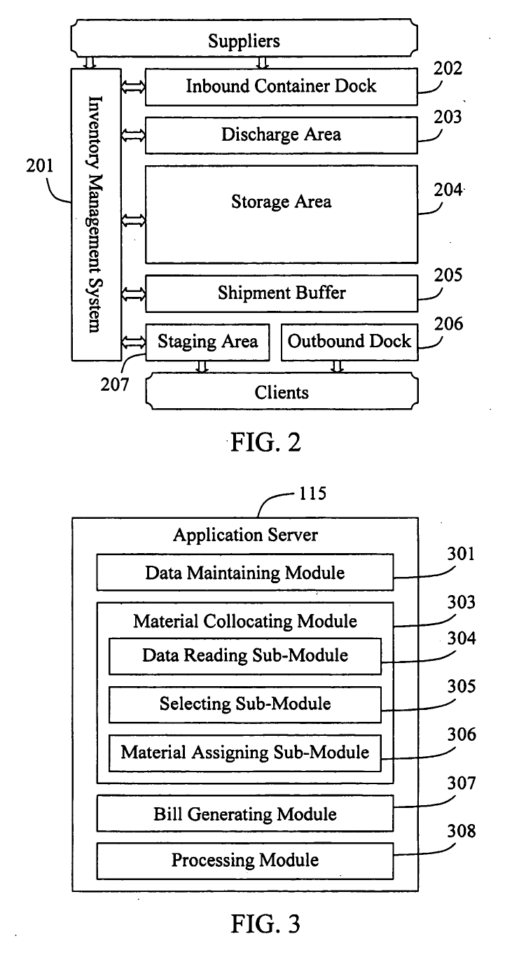

FIG. 2 is a block diagram of an organizational layout of a warehouse in which materials are stored, in accordance with the present invention. Typically, the warehouse is located near the premises of a client, making it convenient to deliver inventory to the client. The warehouse comprises six main areas: an inbound container dock 202, a discharge area 203, a storage area 204, a shipment buffer 205, a staging area 207, and an outbound dock 206. The discharge area 203 is used for temporarily storing offloaded inbound inventory. Generally, inventory flows from a supplier to a client through said six main areas. The storage area 204 is divided into a plurality of areas, and each area has an area code. Each area of the storage area 204 is divided into a plurality of units, and each unit has a unit code. The area codes and the unit codes help to precisely locate materials stored in the warehouse.

An inventory management system 201 manages the processes of receiving, storing, and shipping inventory. The system for collocating materials is one part of the inventory management system 201, and is used to manage the process of collocating materials. In a typical application environment of the present invention, the supplier is an organization that supplies materials, and the supplier owns the materials. The client is the organization that uses the materials. The client may be a factory or a third party client. The factory may be a manufacturing shop floor located adjacent the warehouse. The third party client may be located more distant from the warehouse, in which case the materials must be transported a relatively long distance before being used by the third party client. Once the materials leave the warehouse, ownership of the materials switches to the client.

FIG. 3 is a block diagram of function modules of the application server 115. The application server 115 comprises a data maintaining module 301, a material collocating module 303, a bill generating module 307, and a processing module 308.

The data maintaining module 301 is used to maintain basic data of the system for collocating materials, which data is stored in the database server 117. Such maintenance includes defining, establishing, adding, modifying, deleting and querying the basic data. The basic data of the system for collocating materials comprise data on warehouses, suppliers, clients, and materials. The warehouse data comprise data on area codes of the warehouses, and unit codes of units in each area. The supplier data comprise data on codes of the suppliers, names of the suppliers, EDI codes of the suppliers, EDI names of the suppliers, addresses of the suppliers, types of the suppliers, and so on. The client data comprise data on codes of the clients, names of the clients, EDI codes of the clients, EDI names of the clients, addresses of the clients, types of the clients, and so on. The materials data comprise data on codes of the suppliers that own the materials, codes of the clients that are to own the materials, codes of the materials, inbound times of the materials, and forecast outbound times of the materials. The above-mentioned basic data are processed by the inventory management system 201, and form inventory data.

The bill generating module 307 generates shipment bills in accordance with requirements of clients, and comprises data on client codes, material codes, and quantities of materials. The processing module 308 manages the procedure of the shipment in different shipment modes. The procedure comprises selecting a shipment bill, checking the shipment bill, transporting the materials, switching ownership of the materials, and generating a passport.

The material collocating module 303 collocates materials in accordance with a shipment bill. The procedure of collocating comprises selecting a supplier, and searching for areas and units of corresponding stored materials. The material collocating module 303 further comprises a data reading sub-module 304, a selecting sub-module 305, and a material assigning sub-module 306. The data reading sub-module 304 is used to read data stored in the shipment bill, the data comprising data on clients, materials etc. The selecting sub-module 305 is used to select a supplier in accordance with clients and materials. Any one client may have more than one supplier of one material. The system for collocating materials can designate priority of several suppliers of one material. For example, suppliers A, B, and C supply client A material A, and the priority of the three suppliers are supplier A, supplier B, and supplier C. If inventory of supplier A cannot provide enough material A to client A, supplier B is called upon to provide the remainder, and then supplier C is called upon to provide any remainder if necessary. The material assigning sub-module 306 assigns materials in accordance with the shipment bill, and adds area codes, unit codes and quantities of the materials to the shipment bill.

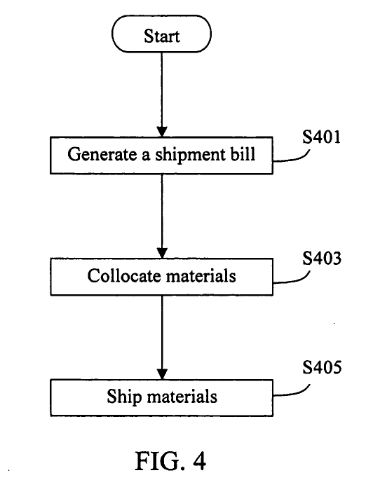

FIG. 4 is a flow chart of shipment of materials in accordance with the present invention. Firstly, in step S401, the bill generating module 307 generates a shipment bill in accordance with a requirement of a client. The requirement of the client may be a manufacturing order of a factory, or an order form of a third party client or the factory. The requirement of the client can be generated by an MRPII or ERP system of the enterprise, or by manual input of a user. The shipment bill comprises data on a client code, material codes, and quantities of materials. In step S403, the material collocating module 303 collocates the materials in accordance with the shipment bill. The material collocating module 303 selects a supplier in accordance with the client code of the shipment bill, and adds respective area codes and unit codes to the shipment bill in accordance with supplier codes, material codes, and quantities of the materials.

In step S405, the processing module 308 manages the procedure of materials loading and shipping. Workers at the warehouse transport the materials from the storage area 204 to the outbound dock 206 or the staging area 207 in accordance with the area codes and unit codes of the shipment bill. For the purposes of simplicity, it will be assumed hereafter that the materials are transported to the outbound area 206. The processing module 308 modifies a depository of the materials as the outbound area 206 on the shipment bill. In the outbound dock 206, the material codes and quantities of the materials are input in the inventory management system 201 for checking of the shipment bill. The first processing module 309 switches ownership of the materials input in the inventory management system 201, and generates a shipment form. The process of switching ownership of the materials comprises the actions of: the processing module 308 sending a receipt confirmation to the supplier via the EDI server 113 and the EDI VAN 105; and the data maintaining module 301 updating materials data stored in the database server 117. The processing module 308 generates a passport in accordance with the material codes and quantities input in the inventory management system 201. The processing module 308 updates an inventory record in the outbound dock 206 via the data maintaining module 301, and generates a shipment record.

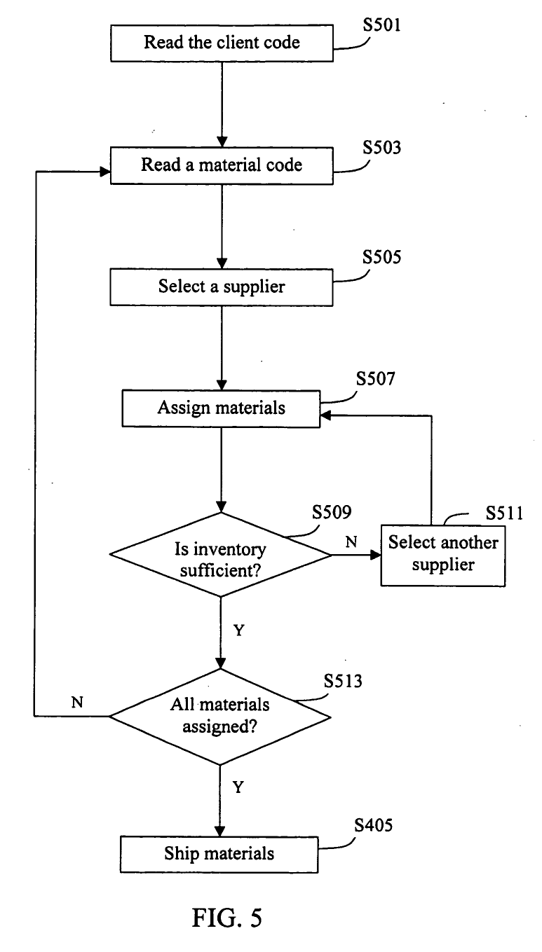

FIG. 5 is a flow chart of details of step S403 of FIG. 4, namely collocating materials. In step S501, the data reading sub-module 304 reads the client code from the shipment bill. In step S503, the data reading sub-module 304 reads material codes one by one. In step S505, the selecting sub-module 305 selects a supplier for each material in accordance with the client codes and the material codes, and sends the corresponding supplier codes to the material assigning sub-module 306. In step S507, the material assigning sub-module 306 assigns corresponding area codes and corresponding unit codes to each material in accordance with the supplier codes, the material codes and the material quantities, and adds the area codes and the unit codes to the shipment bill.

In step S509, the material assigning sub-module 306 determines whether the inventory of the supplier is sufficient. If the inventory is not sufficient, in step S511, the material assigning sub-module 306 selects another supplier in accordance with the priority of the suppliers, and then the procedure returns to step S507. If the inventory is sufficient, in step S513, the data reading sub-module 304 checks the shipment bill, and determines whether all the materials have been assigned. If any material has not been assigned, the procedure returns to step S503. If and when all materials have been assigned, the procedure goes to step S405.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A system for collocating materials, the system comprising an application server, and a database server connected with the application server via a network, wherein:
the application server manages shipment procedures, and comprises:
a bill generating module for generating a shipment bill in accordance with a requirement of a client;
a material collocating module for collocating materials in accordance with the shipment bill;
a processing module for managing shipment procedures in different shipment modes; and
the database server stores basic data related to collocating materials of the application server.

2. The system as claimed in claim 1, further comprising a workstation located in a warehouse for accessing the application server.

3. The system as claimed in claim 1, wherein the shipment bill comprises data on a client code, supplier codes, material codes and material quantities.

4. The system as claimed in claim 1, wherein the basic data stored in the database server comprises warehouse data, client data, supplier data and material data.

5. The system as claimed in claim 1, wherein the application server further comprises a data maintaining module for defining, establishing, adding, modifying, deleting and querying the basic data stored in the database server.

6. The system as claimed in claim 1, wherein the material collocating module comprises a data reading sub-module for reading the client code, the material codes, and material quantities from the shipment bill.

7. The system as claimed in claim 6, wherein the material collocating module further comprises a selecting sub-module for selecting a supplier in accordance with the client code and a respective material code.

8. The system as claimed in claim 7, wherein the selecting sub-module selects one or more suppliers in accordance with a designated priority.

9. The system as claimed in claim 7, wherein the material collocating module further comprises a material assigning sub-module for assigning one or more area codes, unit codes and quantities to a material.

10. A method for collocating materials, the method comprising the steps of:
generating a shipment bill;
collocating materials in accordance with the shipment bill; and
managing a shipment procedure.

11. The method as claimed in claim 10, wherein the step of collocating materials further comprises the steps of:
reading a client code from the shipment bill;
reading a material code and a quantity from the shipment bill;
selecting a supplier in accordance with the client code and the material code; and
assigning one or more area codes and unit codes to the material.

12. The method as claimed in claim 11, wherein the step of selecting a supplier further comprises the steps of:
checking an inventory of the supplier; and
selecting another supplier in accordance with a designated priority, if said inventory of the supplier is insufficient.

13. A method for collocating materials, the method comprising the steps of:
generating a shipment bill;
reading a client code from the shipment bill;
reading a material code and a quantity from the shipment bill;
selecting a supplier in accordance with the client code and the material code;
assigning one or more area codes and unit codes to the material; and
managing a shipment procedure.
